(19) United States
(12) Patent Application Publication
(10) Pub. No.: US 2006/0023150 A1
(43) Pub. Date: Feb. 2, 2006

(54) Electro-optical-device driving circuit, electro-optical device, and electronic apparatus

(75) Inventor: Hiroaki Mochizuki, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/175,256

(22) Filed: Jul. 7, 2005

(30) Foreign Application Priority Data
Jul. 30, 2004 (JP) 2004-223496
May 18, 2005 (JP) 2005-145053

(51) Int. Cl. G02F 1/1343

(52) U.S. Cl. 349/139

(57) ABSTRACT

There is provided a circuit for driving an electro-optical device including a plurality of data lines, a plurality of scanning lines extending perpendicular to the plurality of data lines, and a plurality of pixel units that are electrically connected to the data lines and the scanning lines, respectively, and that are arranged in an image display region. The circuit for driving an electro-optical device includes a shift register that sequentially outputs transmission signals from each stage thereof; a plurality of branch wiring lines which are provided corresponding to the respective stages, and each of which has an input terminal to which the transmission signals are input and m output terminals, where m is a natural number equal to or greater than 2, which are branched from the input terminal and through which the input transmission signals are output; a plurality of enable signal supply lines that respectively supply m types of enable signals having different output timings and a predetermined pulse width smaller than that of the transmission signal; an enable circuit that outputs signals whose pulse widths are shaped to the predetermined pulse width, based on the enable signals; and a sampling circuit that samples image signals, based on the shaped signals, and then outputs them to the plurality of data lines, respectively. The enable circuit includes a plurality of unit circuits. The unit circuits electrically connect the m branched output terminals to the enable signal supply lines for supplying the different types of enable signals, respectively. Each group is composed of m unit circuits, and the unit circuits belonging to the group have the same layout.

### BACKGROUND OF THE INVENTION

1. Technical Field

The present invention relates to an electro-optical-device driving circuit mounted in an electro-optical device, such as a liquid crystal display device, to an electro-optical device, and to an electronic apparatus including an electro-optical device.

2. Related Art

This type of driving circuit is composed of, for example, a data line driving circuit for driving data lines and a scanning line driving circuit for driving scanning lines, which are provided on a substrate of an electro-optical device, such as a liquid crystal display device. The driving circuit samples image signals supplied to image signal lines at the pulse timing of a sampling-circuit driving signal and then outputs the sampled signals to the data lines. In particular, when a driving frequency is high, a front end and a rear end of the sampling-circuit driving signal, in terms of phase, which is used for sampling, hardly overlap each other in time. Therefore, the image signals to be sampled at different times partially overlap each other, and are then output to the data lines, which results in reduced resolution and an increase in manufacturing costs.

In order solve these problems, an enable circuit has been provided in the driving circuit in the related art. The enable circuit is a circuit for calculating the logical product of sampling-circuit driving signals and enable signals. The pulse width of each sampling-circuit driving signal is reduced to the pulse width of the enable signal. In general, the output of the enable circuit is called a sampling-circuit driving signal, and the original signal input to the enable circuit is called a transmission signal. When the pulse width is restricted as described above, a small time interval occurs, as a time margin, between two sampling-circuit driving signals arranged at the front and rear sides in terms of phase. Therefore, even if, for example, the on-resistance of active elements, such as thin film transistors (hereinafter, referred to as TFTS) constituting the sampling circuit, the data line driving circuit, etc., the wiring resistance of various wiring lines, and capacitance and delay caused by the elements or wiring lines are relatively increased due to high-frequency driving, it is possible to reduce the negative effects of the above-mentioned factors (see Japanese Unexamined Patent Application Publication No. 2000-227784).

However, this type of electro-optical device has a technical problem in that strip-shaped marks occur on a screen periodically, which causes the deterioration of display quality. As described above, the findings of the inventors demonstrate that the strip-shaped marks occur in the data lines that are simultaneously driven, which causes variation of the sampling-circuit driving signals.

### SUMMARY

An advantage of the invention is that it provides an electro-optical-device driving circuit capable of preventing display defects appearing in groups of data lines that are simultaneously driven, caused by the variation of sampling-circuit driving signals, when a plurality of data lines are driven at the same time, and that it provides an electro-optical device, such as a liquid crystal display device, and an electronic apparatus, such as a liquid crystal projector.

According to an aspect of the invention, there is provided a circuit for driving an electro-optical device including a plurality of data lines, a plurality of scanning lines extending perpendicular to the plurality of data lines, and a plurality of pixel units that are electrically connected to the data lines and the scanning lines, respectively, and that are arranged in an image display region. The circuit for driving an electro-optical device includes a shift register that sequentially outputs transmission signals from each stage thereof; a plurality of branch wiring lines which are provided corresponding to the respective stages, and each of which has an input terminal to which the transmission signals are input and m output terminals, where m is a natural number equal to or greater than 2, which are branched from the input terminal and through which the input transmission signals are output; a plurality of enable signal supply lines that respectively supply m types of enable signals having different output timings and a predetermined pulse width smaller than that of the transmission signal; an enable circuit that outputs signals whose pulse widths are shaped to the predetermined pulse width, based on the enable signals; and a sampling circuit that samples image signals, based on the shaped signals, and then outputs them to the plurality of data lines, respectively. In this device, the enable circuit includes a plurality of unit circuits, and the unit circuits electrically connect the m branched output terminals to the enable signal supply lines for supplying the different types of enable signals, respectively. In addition, each group is composed of m unit circuits, and the unit circuits belonging to the group have the same layout.

According to the circuit for driving an electro-optical device of the invention, the transmission signals are sequentially output from the respective stages by the shift register, based on a clock signal having a predetermined period. At the same time, enable signals having a predetermined pulse width that are supplied from the outside or are previously generated in the driving circuit are output. Subsequently, the enable circuit performs trimming on each transmission signal, using the enable signal having a smaller pulse width, to restrict the pulse width of the transmission signal, and then outputs the signals as shaped signals. Here, the ‘enable circuit’ is defined as a pulse shaping circuit, and the trimming is performed by the logical product (AND) or negative AND (NAND). When the enable circuit is composed of an AND circuit, the output of the enable circuit is directly input to the sampling circuit. When the enable circuit is composed of a NAND circuit, it is necessary to provide a buffer (NOT circuit) between the enable circuit and the sampling circuit. The shaped signals or signals obtained by further processing the shaped signals are input to the sampling circuit as sampling-circuit driving signals.

Successively, the sampling circuit samples the image signals supplied from the outside based on the sampling-circuit driving signals and then outputs the sampled signals to the data lines. As a result, in the image display region of the electro-optical device, each pixel modulates light according to the image signals supplied through the data lines, thereby performing image display.

Here, m types of transmission signals output from the respective stages of the shift register are supplied through wiring lines each having m output terminals branched therefrom (where m is a natural number equal to or greater than 2). These m types of transmission signals are connected to enable signal supply lines to be input to m unit circuits of the enable circuit, respectively. That is, the enable circuit is composed of a plurality of unit circuits each receiving one of the transmission signals to output one of the sampling-circuit driving signals, based on the received transmission signal. In addition, m or more types of enable signals are supplied in this structure.

The same transmission signal is input to the m unit circuits. However, since the pulse widths thereof are defined by different enable signals, m sampling-circuit driving signals having different output timings are output. As such, plural types of enable signals are treated as different signals, and each enable signal defines the output timing. Therefore, it is possible to increase a driving frequency by time-dividing one transmission into a plurality of transmission signals and then by supplying the transmission signals to a plurality of data lines, respectively.

In the electro-optical device driven by the driving circuit having the above-mentioned structure, strip-shaped marks may periodically occur on a screen. The survey of the inventors proved that the strip-shaped marks appear on the screen as the shades of the data lines that are driven at the same time, and are caused by the variation of the sampling-circuit driving signals for controlling the driving timing of the data lines. The variation can be caused by various factors, such as the variation between the enable signals caused by the wiring resistance of the enable signal supply lines and the parasitic capacitance of the enable circuit and the sampling circuit. However, the inventors pay attention to the layout of the enable circuit among these factors. That is, when the symmetry of a plurality of unit circuits or gaps between wiring lines is broken, the variation of a signal voltage occurs due to an electrical influence, such as parasitic capacitance, at the time of high-frequency driving.

Of the driving circuit, the shift register generally has a high-symmetry circuit structure, and a circuit portion arranged at the rear stage of the enable circuit that is composed of the sampling circuit, etc., is generally an aggregate of circuits respectively corresponding to the data lines. In the present state, the symmetry of a circuit layout for every data line is maintained to some extent. On the contrary, generally, in the enable circuit, m unit circuits belonging to each group to which the same transmission signal is supplied have a mirror symmetry layout. For example, a pair of unit circuits that are connected to two branch lines and to which the same transmission signal is supplied have a mirror symmetry structure. This is a very general structure to use common wiring lines, such as power supply lines in common to reduce pitch between wiring lines because each unit circuit has a relatively large number of circuit elements, such as NAND circuits.

However, in this case, a distance between the unit circuits using common wiring lines thereof becomes small, but a distance between the unit circuits not using common wiring lines thereof becomes large. In addition, a relative distance between a wiring line or element of a certain unit circuit and wiring lines or elements of adjacent unit circuits arranged at the right and left sides thereof is different from each other according to a layout. This irregularity of the distance between the wiring lines or elements may cause the generation of a larger amount of noise from the viewpoint of high-frequency noise.

In the invention, the unit circuits of the same group have the same layout. The ‘same layout’ is an independent layout structure not having common wiring lines, and means that conductive layers constituting a circuit have the same pattern and forming position. In this structure, any unit circuit has the same degree of electrical influence on adjacent unit circuits in each group. That is, since the sampling-circuit driving signals output from the same group are generated by the unit circuits having the same electrical influence, the variation therebetween is prevented. Further, since an important point of the invention is the relative distance between the wiring lines or elements of the enable circuit, the ‘layout’ to be made equal may be a plane layout or a three-dimensional layout.

Therefore, in the electro-optical-device driving circuit of the invention, the unit circuits belonging to each block to which the same transmission signal is input have the same layout in the enable circuit. Therefore, it is possible to prevent the variation of the sampling-circuit driving signals to be output and thus to prevent the generation of display defects, particularly, strip-shaped marks.

Further, in the above-mentioned structure, it is preferable that the unit circuits be arranged at equal intervals in each group.

According to this structure, the unit circuits of each group have the same layout, and distances between adjacent unit circuits are equal to each other. Therefore, adjacent unit circuits receive the same degree of electrical influence, and thus it is possible to further prevent a variation of electrical influence between the unit circuits.

Furthermore, it is preferable that the unit circuits have the same layout in the plurality of groups.

According to this structure, the unit circuits have the same layout in the plurality of groups, as well as in one group. Therefore, the electrical influence of unit circuits adjacent to each other with a boundary between the groups interposed therebetween on a unit circuit located at the boundary between the groups can be made approximately equal to the influence of unit circuits adjacent to one circuit unit on the one unit circuit in the same group.

Moreover, it is preferable that the plurality of groups be arranged at equal intervals.

According to this structure, the distances between the unit circuits are equal to each other in the plurality of groups, as well as in one group. Therefore, the electrical influence of unit circuits adjacent to each other with a boundary between the groups interposed therebetween on a unit circuit located at the boundary between the groups can be made approximately equal to the influence of unit circuits adjacent to one circuit unit on the one unit circuit in the same group.

Further, it is preferable that, in each branch wiring line, the lengths of the m branched portions from a branching point to the m unit circuits be equal to each other. In addition, preferably, in each branch wiring line, lengths from the input terminal to the respective output terminals are equal to each other.

According to this structure, the same transmission signal is supplied from the output terminals having the same length to each group of the enable circuit. Therefore, m supplied transmission signals are affected by the same degree of waveform distortion due to the resistance of wiring lines.

Furthermore, it is preferable that a plurality of second unit circuits having the same layout be provided at rear stages of the unit circuits, respectively.

According to the above-mentioned structure, the sampling circuit provided at the rear stage of the enable circuit is composed of an aggregate of the second unit circuits each provided corresponding to the unit circuit. The second unit circuits have the same layout. For example, each second unit circuit may be composed of a sampling switch that is provided at the rear stage of the unit circuit with a buffer interposed therebetween. When the “unit circuits” having the same layout are provided at the respective stages of the driving circuit as constituent units, it is possible to prevent the variation of signals transmitted between the unit circuits.

Moreover, in the electro-optical-device driving circuit, preferably, each branch wiring line has two branched output terminals, and four types of enable signals are supplied. In addition, it is preferable that the enable circuit include first groups each composed of a pair of unit circuits to which two of the four-types of enable signals are supplied and second groups each composed of a pair of unit circuits to which the other types of signals thereof are supplied, the first and second groups being arranged alternately.

According to this structure, the same transmission signal output from the shift register is input to the enable circuit through two branch lines. In order to generate two types of sampling-circuit driving signals from the same transmission signal input through two branch lines, two types of enable signals are respectively input to a pair of unit circuits to which the same transmission signal is input through two branch lines, respectively. In this way, a sampling-circuit driving signal having a double frequency is generated.

In the invention, four types of enable signals are used in the enable circuit. However, two types of enable signal may be used therein. That is, four different types of enable signals are supplied to pairs of unit circuits two by two. Four types of enable signals have lower pulse frequencies than those of two types of enable signals. Therefore, when a driving frequency is high, four types of enable signals are preferable in order to easily generate them. In addition, for the above-mentioned object, four or more types of enable signals, such as six types of enable signals and eight types of enable signals, can be used. However, in practice, four types of enable signals are preferable in consideration of the extension of wiring lines or an error in pulse waveform between enable signals. In this case, each branch wiring line has two output terminals branched therefrom, and the two output terminals may be arranged so as to be symmetric with respect to the input terminal. In this way, it is possible to prevent the variation of signals caused by an unequal layout.

According to another aspect of the invention, an electro-optical device includes the above-mentioned electro-optical-device driving circuit (however, which includes the above-mentioned structures), the plurality of data lines, the plurality of scanning lines, and the plurality of pixel units.

According to the above-mentioned structure, since the electro-optical device of the invention includes the electro-optical-device driving circuit, it is possible to prevent the generation of display defects, particularly, strip-shaped display marks, and thus to achieve high display quality. In addition, it is possible to realize, using the electro-optical device of the invention, various display devices, such as liquid crystal display devices, organic EL devices, electrophoresis devices, such as electronic papers, and field emission display devices and surface-conduction electron-emitter display devices using electron emitting elements.

According to still another aspect of the invention, an electronic apparatus includes the above-mentioned electro-optical device (however, which includes the above-mentioned structures).

According to this structure, the electronic apparatus of the invention includes the above-mentioned electro-optical device. In addition, the electro-optical device has the electro-optical-device driving circuit mounted thereon. Therefore, the electronic apparatus of the invention can display high-quality images. Further, the electro-optical device of the invention can be applied to various electronic apparatuses, such as a projection display apparatus, a television set, a cellular phone, an electronic organizer, a word processor, a view-finder-type or monitor-direct-view-type videotape recorder, a workstation, a television phone, a POS terminal, and apparatuses equipped with touch panels.

Other advantages and effects of the invention will become more apparent from the following description of the embodiments.

### BRIEF DESCRIPTION OF THE DRAWINGS

The invention will be described with reference to the accompanying drawings, wherein like numbers reference like elements, and wherein:

FIG. 1 is a plan view illustrating the overall structure of an electro-optical device according to an embodiment of the invention;

FIG. 2 is a cross-sectional view taken along the line II-II of FIG. 1;

FIG. 3 is a plan view illustrating a circuit structure of a TFT array substrate of the electro-optical device according to the embodiment;

FIG. 4 is a block diagram illustrating the structure of a main driving system of the electro-optical device according to the embodiment;

FIG. 5 is a view illustrating a layout structure of an enable circuit of the circuit system shown in FIG. 4;

FIG. 6 is a view illustrating a layout of a circuit according to a comparative example of FIG. 5;

FIGS. 7A and 7B are views respectively illustrating a layout of wiring lines between a shift register and the enable circuit in the circuit system shown in FIG. 4;

FIG. 8 is a timing chart illustrating a method of driving the electro-optical device according to another embodiment; and

FIG. 9 is a cross-sectional view schematically illustrating a projection color display apparatus, which is an example of an electronic apparatus to which the electro-optical device of the invention is applied.

### DESCRIPTION OF THE EMBODIMENTS

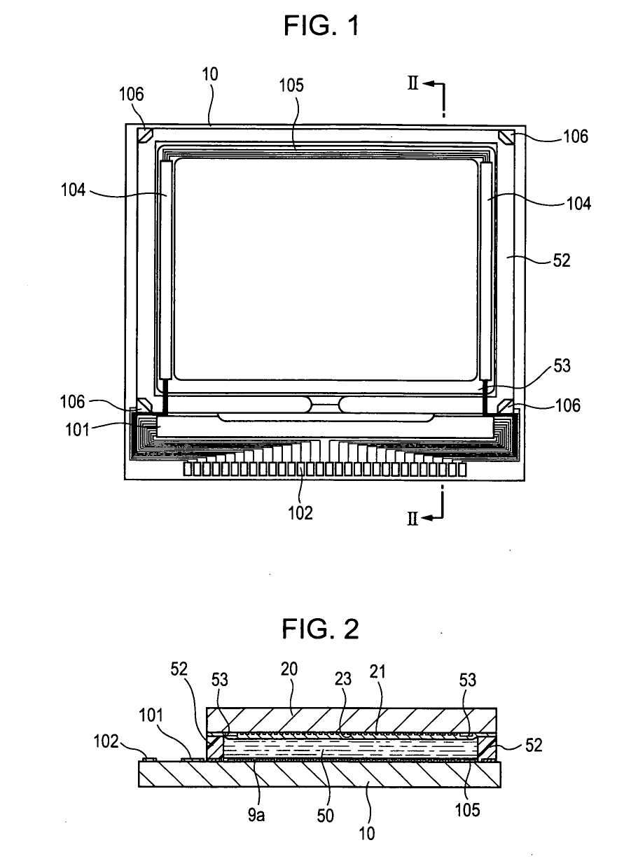

Preferred embodiments of the invention will be described with reference to FIGS. 1 to 6. In the following embodiment, an electro-optical device of the invention is applied to a liquid crystal display device.

Structure of Liquid Crystal Display Device

The overall structure of a liquid crystal display device according to an embodiment of the invention will be described with reference to FIGS. 1 to 3. FIG. 1 is a plan view of the liquid crystal display device, as viewed from a counter substrate, and FIG. 2 is a cross-sectional view taken along the line II-II of FIG. 1.

In FIGS. 1 and 2, the liquid crystal display device includes a TFT array substrate 10 and a counter substrate 20 which are opposite to each other. A liquid crystal layer 50 is interposed between the TFT array substrate 10 and the counter substrate 20, and the TFT array substrate 10 and the counter substrate 20 are bonded to each other by a sealing material 52 provided in a sealing region located around the periphery of an image display region 10a. The sealing material 52 is made of, for example, an ultraviolet-curable resin or a thermally curable resin, to bond the substrates. In a manufacturing process, the sealing material 52 is applied onto the TFT array substrate 10 and is then hardened by irradiation with ultraviolet rays or by heating. In addition, gap members, such as glass fibers or glass beads, are dispersed in the sealing material 52 to maintain a gap between the TFT array substrate 10 and the counter substrate 20 at a predetermined value. A frame-shaped light-shielding film 53 defining a frame region of the image display region 10a is formed around an inner circumference of the sealing region having the sealing material 52 arranged therein on the counter substrate 20. Alternatively, a portion of or the entire frame-shaped light-shielding film 53 may be provided on the TFT array substrate 10 as an integrated light-shielding film.

A data line driving circuit 101 and external circuit connecting terminals 102 are provided along one side of a peripheral region of the image display region 10a on the TFT array substrate 10. Scanning line driving circuits 104 are provided along two sides thereof adjacent to the one side so as to be covered with the frame-shaped light-shielding film 53. In addition, a plurality of wiring lines 105 for connecting the scanning line driving circuits arranged at both sides of the image display region 10a are provided along the remaining one side of the TFT array substrate 10 so as to be covered with the frame-shaped light-shielding film 53. Further, vertically connecting terminals 106 are provided between the TFT array substrate 10 and the counter substrate 20 to secure electrical connection therebetween.

In FIG. 2, on the TFT array substrate 10, pixel electrodes 9a are formed on pixel switching TFTs and various wiring lines, and an alignment film is formed thereon. On the other hand, a counter electrode 21 is formed in the image display region 10a on the counter substrate 20 so as to be opposite to the plurality of pixel electrodes 9a with the liquid crystal layer 50 interposed therebetween. That is, when a voltage is applied between the pixel electrodes 9a and the counter electrode 21, liquid crystal storage capacitors are formed therebetween, respectively. A lattice-shaped or strip-shaped light-shielding film 23 is formed on the counter electrode 21, and an alignment film is formed thereon. The liquid crystal layer 50 is composed of one kind of nematic liquid crystal or liquid crystal obtained by mixing several kinds of nematic liquid crystal, and the liquid crystal is arranged between the two alignment films in a predetermined alignment state.

Although not shown in FIG. 2, other circuits, such as a sampling circuit 7, which will be described later, are formed on the TFT array substrate 10, as well as the data line driving circuit 101 and the scanning line driving circuits 104. In addition to these circuits, for example, a test circuit may be provided for evaluating the quality and testing for defects of the liquid crystal display device during manufacture or prior to shipping. Further, polarizing films, retardation films, polarizing plates, etc., are respectively formed in predetermined directions on a surface of the counter substrate 20 on which projection light is incident and-a surface of the TFT array substrate 10 from which light is emitted, according to the operating mode, such as a TN (twisted nematic) mode, an STN (super TN) mode, and a D-STN (double STN) mode, or the display mode, such as a normally white mode and a normally black mode. A description has been given above of the schematic structure of the liquid crystal display device.

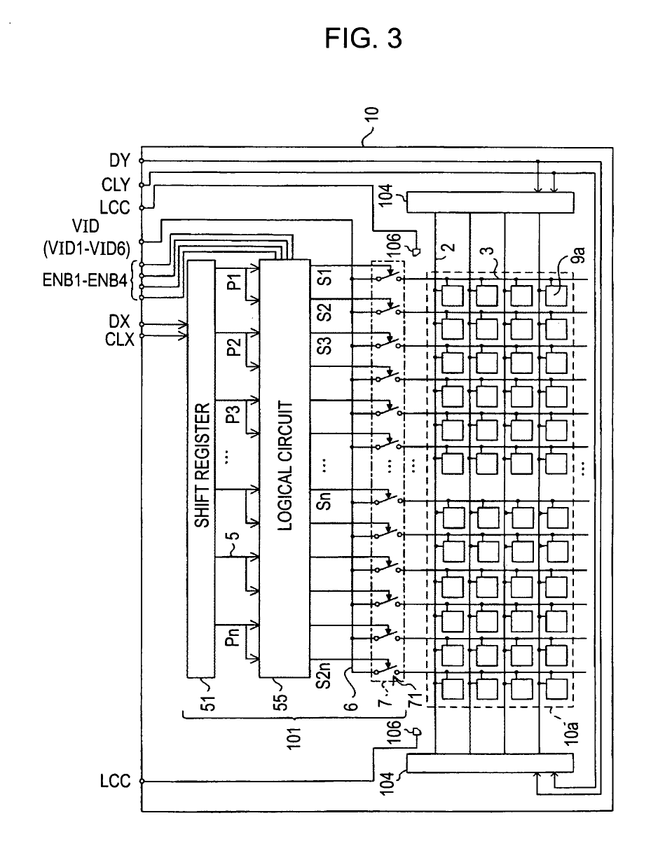

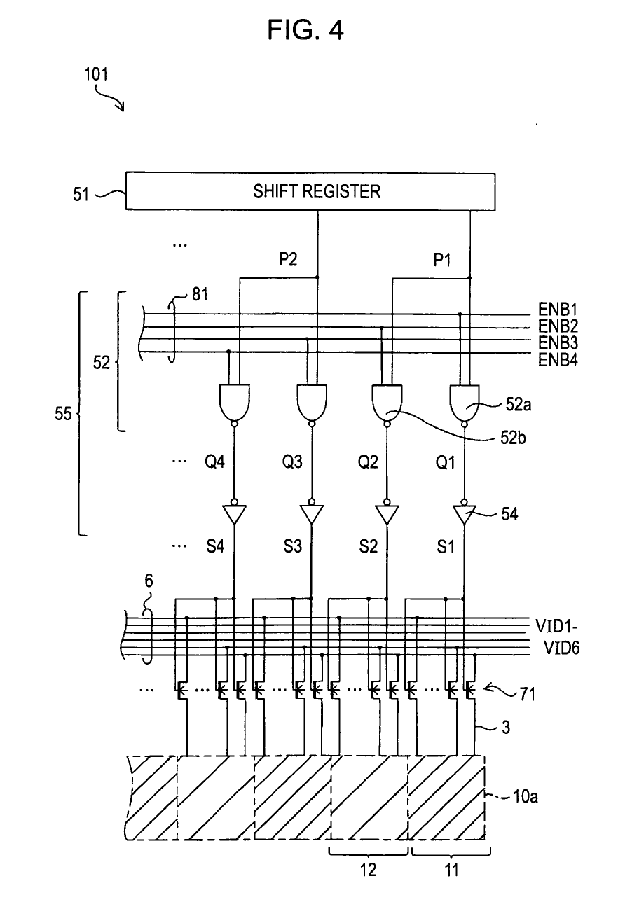

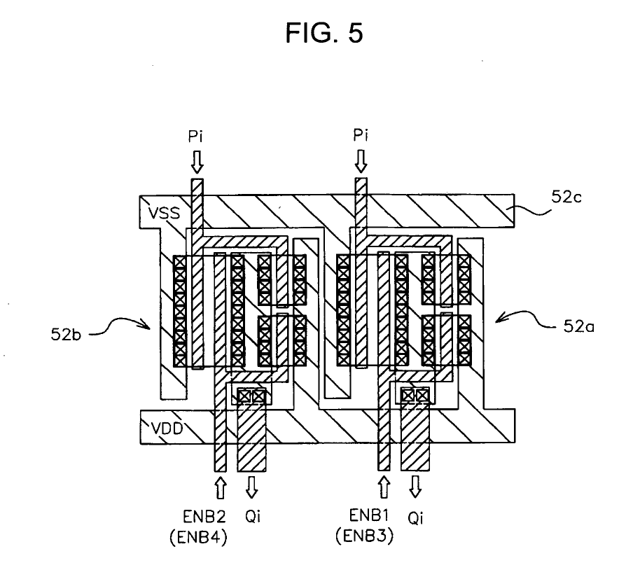

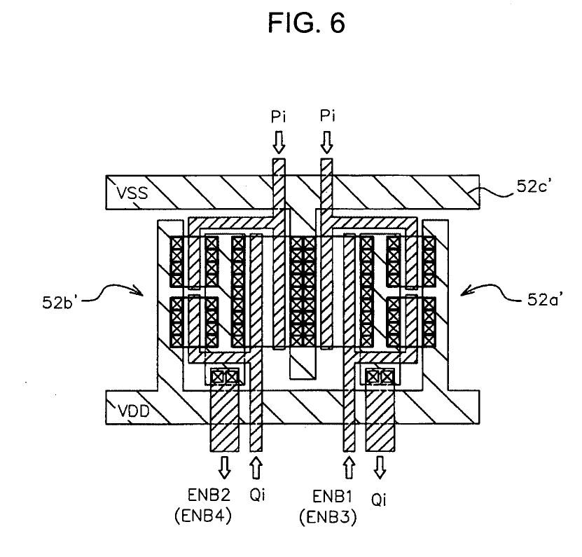

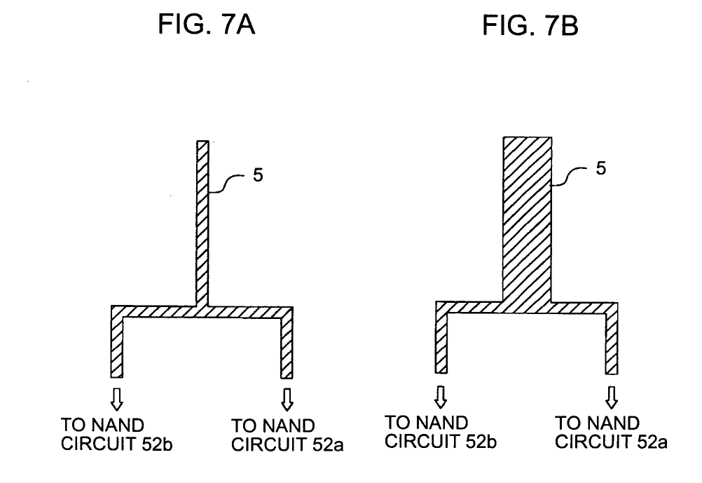

Next, the main structure of the liquid crystal display device will be described with reference to FIGS. 3 to 7. FIG. 3 is a view illustrating the main structure of the liquid crystal display device. However, for the convenience of explanation, an inverse structure of that shown in FIG. 1 is illustrated in FIG. 3. FIG. 4 shows a driving circuit system related to the shaping of a transmission signal in the structure shown in FIG. 3, and FIG. 5 shows a circuit layout of an enable circuit in the circuit system shown in FIG. 4. In addition, FIG. 6 shows a comparative example of the circuit layout shown in FIG. 5, and FIG. 7 shows a layout of wiring lines between a shift register and the enable circuit.

In FIGS. 3 and 4, in the liquid crystal display device, the TFT array substrate 10 and the counter substrate 20 (not shown in FIGS. 3 and 4), which are respectively composed of quartz substrates, glass substrates, or silicon substrates, are opposite to each other with the liquid crystal layer interposed therebetween, and an electric field applied to the liquid crystal layer is modulated in each pixel by controlling a voltage applied to the pixel electrodes 9a in the image pixel region 10a. In this way, the amount of transmission light between the two substrates is controlled, and thus gray-scale display of an image is performed. The liquid crystal display device adopts a TFT active matrix driving method, and the image display region 10a of the TFT array substrate 10 has a plurality of pixel electrodes 9a arranged in a matrix, a plurality of scanning lines 2, and a plurality of data lines 3 arranged perpendicular to the scanning lines 2 therein. In addition pixel units are formed at intersections of the scanning lines 2 and the data lines 3, respectively. Although not shown in FIGS. 3 and 4, a TFT that is turned on or off by a scanning signal supplied through the scanning line 2 and a storage capacitor for holding a voltage applied to the pixel electrode 9a are formed between the data line 3 and each pixel electrode 9a. In addition, driving circuits for the electro-optical device, such as the data line driving circuit 101 and the scanning line driving circuits 104, are formed in the peripheral region of the image display region 10a as an example of a circuit for driving an electro-optical device.

The data line driving circuit 101 includes a shift register 51, a logical circuit 55, and a sampling circuit 57. The shift register 51 is constructed so as to sequentially output transmission signals Pi (where i=1, 2, . . . , n) from each state, based on an X clock signal CLK having a predetermined period (and an inversion signal CLK′ thereof) that is input to the data line driving circuit 101 and a shift register signal DX.

The logical circuit 55 is composed of an enable circuit 52 and a NOT circuit 54. The enable circuit 52 shapes the pulse waveforms of the transmission signals Pi (where i=1, 2, . . . , n), based on four types of enable signals ENB1 to ENB4, to output shaped signals Qi (where i=1, 2, . . . , 2n). The transmission signals Pi (where i=1, 2, . . . , n) and the enable signals ENB1 to ENB4 respectively supplied from four enable signal supply lines 81 are applied to the enable signal 52.

As shown in FIG. 4, the enable circuit 52 has a plurality of pairs of NAND circuits, and each pair of NAND circuits, that is, NAND circuits 52a and 52b, serving as ‘unit circuits’, is connected to a wiring line 5. Each of the NAND circuits 52a and 52b, serving as ‘unit circuits’, outputs one of the shaped signals Qi (where i=1, 2, . . . , 2n) based on one of the input transmission signals Pi (where i=1, 2, . . . , n). In this embodiment, a pair of the NAND circuits 52a and 52b corresponds to an example of a ‘group’ of the invention. More specifically, the same transmission signal Pi (where i=1, 2, . . . , n) and two signals having different phases of the four types of enable signals ENB1 to ENB4 are supplied to the NAND circuits 52a and 52b, respectively, and then each of the NAND circuits 52a and 52b calculates negative AND (NAND) between the transmission signal and the enable signal to output the calculated signal as the shaped signal Qi (where i=1, 2, . . . , 2n).

Further, the enable circuit 52 is connected to the shift register 51 by the plurality of wiring lines 5. The transmission signals Pi (where i=1, 2, . . . , n) output from the shift register 51 are input to the NAND circuits 52a and 52b through the wiring lines 5, respectively. Each wiring line 5 has two branched output terminals, so that the same transmission signal is supplied to the enable circuit 52 through two branched lines. Therefore, the number of wiring lines at the input side is half the number of wiring lines at the output side. This structure contributes to a reduction in the space required for the wiring layout and a decrease in pitch.

A plurality of NOT circuits 54 are provided corresponding to the NAND circuits 52a and 52b, respectively. These NOT circuit 54 each have a function of inverting the shaped signals Qi (where i=1, 2, . . . , 2n) output from the enable circuit 52. The signals output from the NOT circuits 54 are input to the sampling circuit 7 as sampling-circuit driving signals Si (where i=1, 2, . . . , 2n).

The sampling circuit 7 samples image signals VID supplied to image signal lines 6, based on the sampling-circuit driving signals Si (where i=1, 2, . . . , 2n), which are reference clock signals, and then applies the sampled signals to the data lines 3 as data signals, respectively. For example, as shown in FIG. 4, the sampling circuit 7 includes sampling switches 71 each composed of a single channel TFT, such as a P-channel TFT or an N-channel TFT, or a complementary TFT.

For the convenience of explanation, one image signal line 6 is shown in FIG. 3. However, as shown in FIG. 4, actually, a plurality of image signal lines 6 is provided since image signals are serial-to-parallel converted (that is, phase-expanded). The “serial-to-parallel conversion” is a technique for converting (phase-expanding) a serial image signal to a plurality of parallel image signals, such as three-phase signals, six-phase signals, twelve-phase signals, or twenty-four-phase signals, in order to prevent an increase in driving frequency and to achieve high-precision image display, and the converted signals are supplied to the electro-optical device through a plurality of image signal lines. In this case, the plurality of image signals are simultaneously sampled by the plurality of sampling switches, and the sampled signals are respectively supplied to the plurality of data lines at the same time. In this embodiment, the image signal is serial-to-parallel converted into six phases, and these image signals. VID1 to VID6 are input to the sampling circuit 7 through the six image signal lines 6, respectively. In addition, one sampling-circuit driving signal Si (where i=1, 2, . . . , 2n) is simultaneously input to six sampling switches 71 such that these six image signals VID1 to VID6 are sampled by the respective sampling switches 71 at the same time.

When the parallel image signals obtained by converting the serial image signal are supplied at the same time, the input of image signals to the data lines 3 can be performed for every group, which results in a reduction in the number of driving frequencies. In this embodiment, pixel units of partial regions 11 and 12 in the image display region 10a shown in FIG. 4 are driven as a unit, corresponding to six data lines 3 that are simultaneously driven.

In order to scan the plurality of pixel electrodes 9a arranged in a matrix in a direction where the scanning lines 2 are arranged, using the data signals and the scanning signals, the scanning line driving circuit 104 sequentially applies, to the plurality of scanning lines 2, the scanning signals generated based on a Y clock signal CLY (and an inversion signal CLY, thereof), which is a reference clock when the scanning signals are applied, and a shift register start signal DY. In this case, a voltage is applied to both ends of each scanning line 2 at the same time.

Further, various timing signals, such as clock signals, are generated by a timing generator (not shown), and are then supplied to various circuits on the TFT array substrate 10. In addition, a power supply voltage required for driving various driving circuits is supplied from an external circuit. A counter electrode potential LCC is supplied from an external circuit to signal lines extending from the vertically connecting terminals 106. The counter electrode potential LCC is supplied to the counter electrode 21 through the vertically connecting terminals 106. In addition, the counter electrode potential LCC is a reference potential of the counter electrode 21 for properly maintaining a difference in potential between the pixel electrodes 9a and the counter electrode 21 to form a liquid crystal storage capacitor therebetween.

Structure of NAND Circuit

As shown in FIG. 5, in this embodiment, the NAND circuits 52a and 52b have the same layout. Therefore, since the NAND circuits 52a and 52b do not have a difference in layout, they interact with each other, or receive the same degree of electrical influence, such as parasitic capacitance, from wiring lines and elements provided therearound, so that a variation in signal values output from each NAND circuit is prevented. Further, in this embodiment, pairs of NAND circuits are arranged at uniform intervals. Therefore, a difference in layout between the pairs of NAND circuits does not occur, and thus the variation of output signal values is prevented.

On the contrary, as shown in FIG. 6, in the general enable circuit, a pair of NAND circuits 52a′ and 52b′ are arranged in a mirror symmetry array. Such symmetric arrays have been coming into widespread use since they can be utilized to commonly use wiring lines and elements arranged between the NAND circuits 52a′ and 52b′ and to achieve a narrow pitch. As shown in FIG. 6, the NAND circuits 52a′ and 52b′ use a common power line 52c′ provided therebetween. However, in this case, the symmetry of the wiring lines or elements in the layout causes the distances therebetween to be irregular. For example, a relative distance between a wiring line or element in a NAND circuit 52a′ and a wiring line or element in a NAND circuit 52b′, two NAND circuit 52a′ and 52b′ constituting a pair, is different from that between the wiring line or element in the NAND circuit 52a′ and a wiring line or element in another NAND circuit 52b′ adjacent to the NAND circuit 52a′ on the right side of FIG. 6. In addition, the pair of NAND circuits 52a′ and 52b′ are close to each other, with the power line 52c′ that is commonly used by them interposed therebetween, and are respectively separated from other NAND circuits 52a′ and 52b′ arranged on an opposite side of the power line 52c′ in an array. When the relative distances are different from each other, the degree of electrical influence acting therebetween, such as parasitic capacitance, becomes different, which causes variation of signal values.

In consideration of such electrical influence, it is preferable to lay out the wiring line 5 so as to be symmetric with respect to a pair of NAND circuits 52a and 52b, as shown in FIGS. 7A and 7B. In FIG. 7A, the wiring line 5 has two branched output terminals that are symmetric with respect to the vertical direction. In FIG. 7B, the output side of the wiring line 5 is split into two terminals having the same width.

As described above, according to the electro-optical device of this embodiment, each pair of NAND circuits 52a and 52b of the enable circuit 52 has the same layout. Therefore, it is possible to prevent the variation of the output sampling-circuit driving signals Si (where i=1, 2, . . . , 2n). As a result, it is possible to prevent a display defect caused by the variation of the sampling-circuit driving signals Si (where i=1, 2, . . . , 2n), particularly, a difference in brightness between the partial regions 11 and 12 appearing as a vertical-stripe-shaped display mark.

Method of Driving Liquid Crystal Display Device

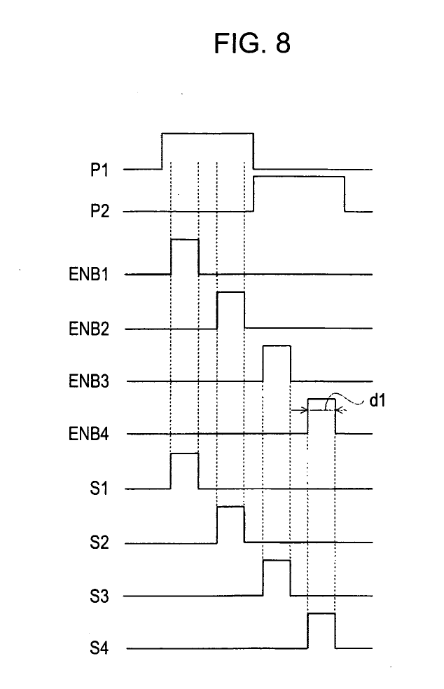

Next, the operation of the liquid crystal display device, particularly, a process of shaping the transmission signals Pi (where i=1, 2, . . . , n) into the sampling-circuit driving signals Si (where i=1, 2, . . . , 2n), will be described with reference to FIGS. 3 to 8. FIG. 8 is a timing chart illustrating various signals used for the driving system shown in FIG. 4.

As shown in the timing chart of FIG. 8, the transmission signals P (where i=1, 2, . . . , n) are output from the shift register 51 of the data line driving circuit 101 in the order of P1, P2, . . . , Pn. In this case, an odd-numbered transmission signal P2k-1 and an even-numbered transmission signal P2k (where k=1, 2, . . . , n/2) are output at a complementary timing. In this embodiment, the same transmission signal Pi (where i=1, 2, . . . , n) is output to the enable circuit 52 of the logical circuit 55 through two wiring lines 5.

In the enable circuit 52, each of the NAND circuits 52a and 52b calculates negative AND between the input transmission signal Pi (where i=1, 2, . . . , n) and any one of the enable signals ENB1 to ENB4. Since the transmission signal Pi (where i=1, 2, . . . , n) is simultaneously input to a pair of NAND circuits 52a and 52b, two different signals of the enable signals ENB1 to ENB4 are input to the NAND circuits 52a and 52b such that the NAND circuits 52a and 52b output the sampling-circuit driving signals Si (where i=1, 2, . . . , 2n) at different timings, respectively. By the negative AND calculated by the NAND circuits 52a and 52b, the waveforms of the transmission signals Pi (where i=1, 2, . . . , n) are trimmed based on the waveforms of the enable signals ENB1 to ENB4 having narrower pulse widths, so that the pulse width thereof is limited to a pulse width d1 of the enable signal. Then, the shaped signals Qi (where i=1, 2, . . . , 2n) obtained in this way are output from the enable circuit 52.

Further, the phases of the enable signals ENB1 to ENB4 deviate so as not to overlap each other. Therefore, the same transmission signal Pi (where i=1, 2, . . . , n) is input to a pair of NAND circuits 52a and 52b through two lines, and then the NAND circuits 52a and 52b respectively output pulse waveforms at different timings, based on the enable signals input thereto. Since the transmission signals Pi (where i=1, 2, . . . , n) are output according to the clock signal CLK, etc., input to the shift register 51, there is a limitation to increasing the frequency thereof due to restrictions of the clock period. However, when the pulse width is restricted by the negative AND between the enable signals and the transmission signals by the enable circuit 52, it is possible to reduce the pulse width.

Here, a pair of NAND circuits 52a and 52b has the same layout, and each pair of NAND circuits 52a and 52b are arranged at equal intervals, which causes substantially the same degree of electrical influence, such as parasitic capacitance, to act between pairs of NAND circuits 52a and 52b. Thus, the variation between the shaped signals Qi (where i=1, 2, . . . , 2n) can be prevented.

Signals output from the NAND circuits 52a and 52b are input to a plurality of NOT circuits 54, respectively. Inversion signals of the shaped signals Qi (where i=1, 2, . . . , 2n) are output from the NOT circuits 54 as the sampling-circuit driving signals Si (where i=1, 2, . . . , 2n). That is, the transmission signals Pi (where i=1, 2, . . . , n) are converted into the sampling-circuit driving signals Si (where i=1, 2, . . . , 2n) having a predetermined pulse width through the enable signal 52 and the NOT circuits 54.

The sampling-circuit driving signals Si (where i=1, 2, . . . , n) drive a group of sampling switches 71 of the sampling circuit 7 to supply the image signals VID1 to VID6 to the sampling switches 71 through the image signal lines 6. In this way, the image signals VID1 to VID6 are sampled. Since the pulse width of the sampling-circuit driving signals Si (where i=1, 2, . . . , 2n) coincides with the pulse width d1, it is possible to set the pulse width of a data signal to be generated to the pulse width d1, and to make the pulse width uniform. In addition, as described above, the variation of the shaped signals Qi (where i=1, 2, . . . , 2n) and the sampling-circuit driving signals Si (where i=1, 2, . . . , 2n) caused by high-frequency noise is prevented. As a result, it is possible to prevent a display defect caused by the variation of the sampling-circuit driving signals Si (where i=1, 2, . . . , 2n), particularly, a difference in brightness between the partial regions 11 and 12, appearing as a vertical-stripe-shaped display mark, to which the image signals are written through the data lines 3 that are driven at the same time.

Although the preferred embodiment of the invention has been described above, the invention is not limited thereto, but various modifications and changes thereof can be made. For example, the number of transmission signals, enable signals, or image signals can be set arbitrarily. In this embodiment, each transmission signal is transmitted to the enable circuit through two branched wiring lines 5. However, the transmission signal may be transmitted thereto through three or more branched lines. In this case, the number of wiring lines connecting the shift register to the enable circuit can be further reduced. However, in this case, the number of types of enable signals must be set larger than the number of divided transmission signals in order to perform optimum driving. In addition, in this embodiment, four enable signals ENB1 to ENB4 are used. However, the number of types of enable signals is not limited thereto, but a smaller number of types of enable signals (for example, two types of enable signals) or a larger number of types of enable signals (for example, eight or more types of enable signals) may be used. When the driving frequency is further increased to cope with higher resolution requirements, the number of types of enable signals increases in order to narrow the pulse width.

Further, in this embodiment, the enable circuit 52 includes the NAND circuits 52a and 52b. However, the enable circuit 52 may be composed of AND circuits each having a function of the NOT circuit 54. Furthermore, in the invention, the ‘unit circuits’ may have the same layout in the ‘group’ provided corresponding to the same type of enable signals. In this case, any circuit structure (including, for example, the type of transistor, the number of elements, and the connecting relationship between elements) can be used so long as the above-mentioned condition is satisfied.

Furthermore, in this embodiment, the transmission signals from the shift register are sequentially output from each stage. This means that the transmission signals are output from each stage in turn, but is not necessarily limited to a case in which the time series of the transmission signals corresponds to the physical arrangement of each stage.

Electronic Apparatus

The above-mentioned liquid crystal display device is applied to, for example, a projector. Here, a projector using the liquid crystal display device according to the above-mentioned embodiment as a light valve will be described.

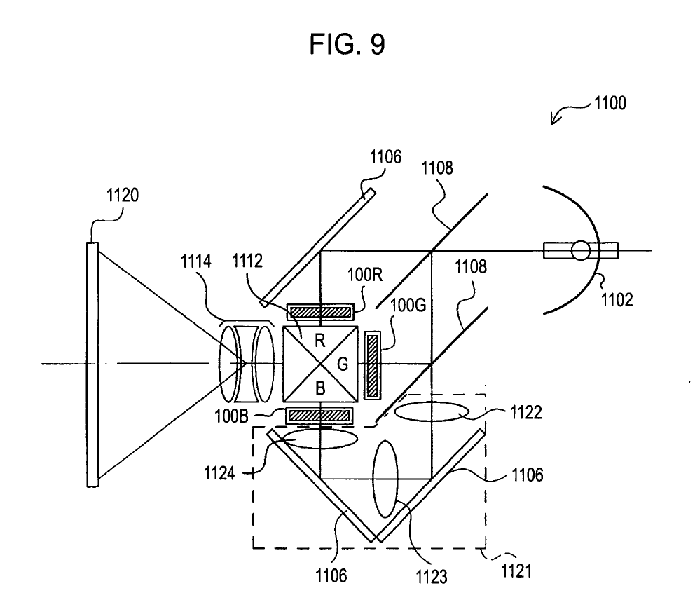

FIG. 9 is a plan view illustrating the structure of a projector. As shown in FIG. 9, a lamp unit 1102 composed of a white light source, such as a halogen lamp, is provided in a projector 1100. Projection light emitted from the lamp unit 1102 is separated into light components corresponding to the three primary colors R (red), G (green), and B (blue) by four mirrors 1106 and two dichroic mirrors 1108 which are arranged in a light guide, and the light components are respectively incident on liquid crystal devices 100R, 100B, and 100G, serving as light valves corresponding to the three primary colors. The constructions of the liquid crystal devices 100R, 100B, and 100G are the same as that of the above-mentioned liquid crystal display device, and R, G, and B signals supplied from an image signal processing circuit are modulated by the liquid crystal devices 100R, 100B, and 100G, respectively. Then, the light components modulated by these liquid crystal devices are incident on a dichroic prism 1112 in three directions. In the dichroic prism 1112, images of the respective colors are combined to be output as a color image. Then, the color image is projected onto a screen 1120 through a projection lens 1114.

Since this projection color display device uses the liquid crystal display device according to the above-mentioned embodiment, little or no brightness spot occurs, and thus it is possible to perform high-quality display.

Further, the liquid crystal display device according to the above-mentioned embodiment can be applied to a direct-view-type or reflective color display device other than the projector. In this case, R, G, and B color filters and a protective film therefor may be formed on regions of the counter substrate 20 opposite to the pixel electrodes 9a. Alternatively, a color filter layer may be formed below R, G, and B pixel electrodes 9a on the TFT array substrate 10, using, for example, a color resist. In all cases described above, when micro lenses are provided on the counter substrate 20 so as to correspond to the pixels one to one, it is possible to improve the condensing efficiency of incident light and thus to improve display brightness. Moreover, several interference layers having different reflective indexes may be formed on the counter substrate 20 to form a dichroic filter for generating R, G, and B colors using the interference of light. The counter electrode having the dichroic filter thereon makes it possible to perform brighter display.

The liquid crystal display device and the liquid crystal projector have been described as examples of the invention, but the invention can be applied to electro-optical devices that can be driven in a matrix manner, other than the liquid crystal display devices. The electro-optical devices include, for example, electro-luminescent devices, electrophoresis devices, and field emission display devices and surface-conduction electron-emitter display devices using electron emitting elements. Further, the electro-optical device of the invention can be applied to various electronic apparatuses, such as a television set, a view-finder-type or monitor-direct-view-type videotape recorder, a car navigation system, a pager, an electronic organizer, an electronic calculator, a word processor, a workstation, a television phone, a POS terminal, and apparatuses equipped with touch panels, in addition to the projector.

The invention is not limited to the above-mentioned embodiment, but various modifications and changes can be made without departing from the scope and sprit of the invention read from the claims and the specification. Such a modified driving circuit for an electro-optical device, the electro-optical device, and various electronic apparatuses comprising the modified electro-optical device will also be included within the technical scope of the invention.

What is claimed is:

1. A circuit for driving an electro-optical device including a plurality of data lines, a plurality of scanning lines extending perpendicular to the plurality of data lines, and a plurality of pixel units that are electrically connected to the data lines and the scanning lines, respectively, and that are arranged in an image display region, comprising:
a shift register that sequentially outputs transmission signals from each stage thereof;
a plurality of branch wiring lines which are provided corresponding to the respective stages, and each of which has an input terminal to which the transmission signals are input and m output terminals, where m is a natural number equal to or greater than 2, which are branched from the input terminal and through which the input transmission signals are output;
a plurality of enable signal supply lines that respectively supply m types of enable signals having different output timings and a predetermined pulse width smaller than that of the transmission signal;
an enable circuit that outputs signals whose pulse widths are shaped to the predetermined pulse width, based on the enable signals; and
a sampling circuit that samples image signals, based on the shaped signals, and then outputs them to the plurality of data lines, respectively,
wherein the enable circuit includes a plurality of unit circuits,
the unit circuits electrically connect the m branched output terminals to the enable signal supply lines for supplying the different types of enable signals, respectively, and
each group is composed of m unit circuits, and the unit circuits belonging to the group have the same layout.

2. The circuit for driving an electro-optical device according to claim 1,
wherein the unit circuits are arranged at equal intervals in each group.

3. The circuit for driving an electro-optical device according to claim 1,
wherein the unit circuits have the same layout between the plurality of groups.

4. The circuit for driving an electro-optical device according to claim 1,
wherein the plurality of groups are arranged at equal intervals.

5. The circuit for driving an electro-optical device according to claim 1,
wherein, in each branch wiring line, the lengths of the m branched portions from a branching point to the m unit circuits are equal to each other.

6. The circuit for driving an electro-optical device according to claim 1,
wherein, in each branch wiring line, lengths from the input terminal to the respective output terminals are equal to-each other.

7. The circuit for driving an electro-optical device according to claim 1,
wherein a plurality of second unit circuits having the same layout are provided at rear stages of the unit circuits, respectively.

8. The circuit for driving an electro-optical device according to claim 1,
wherein each branch wiring line has two branched output terminals, and four types of enable signals are supplied, and
the enable circuit includes first groups each composed of a pair of unit circuits to which two of the four types of enable signals are supplied and second groups each composed of a pair of unit circuits to which the other types of enable signals thereof are supplied, the first and second groups being arranged alternately.

9. The circuit for driving an electro-optical device according to claim 8,
wherein the two branched output terminals in each branch wiring line are arranged so as to be symmetric with respect to the input terminal.

10. An electro-optical device comprising the electro-optical-device driving circuit according to claim 1, a plurality of data lines, a plurality of scanning lines, and a plurality of pixel units.

11. An electronic apparatus comprising the electro-optical device according to claim 9.
